(19) United States
(12) Patent Application Publication
(10) Pub. No.: US 2024/0383567 A1
(43) Pub. Date: Nov. 21, 2024

(54) HUB MOTOR

(71) Applicant: TIEN HSIN INDUSTRIES CO., LTD., Taichung City (TW)

(72) Inventors: CHUN-WEI CHEN, Taichung City (TW); CHANG-CHUN KAO, Taichung City (TW); SHANG-FENG LIN, Taichung City (TW)

(21) Appl. No.: 18/372,149

(22) Filed: Sep. 25, 2023

(30) Foreign Application Priority Data
May 19, 2023 (TW) 112118698

(51) Int. Cl. B62M 6/65; H02K 5/04

(52) U.S. Cl. CPC B62M 6/65; H02K 5/04

(57) ABSTRACT

A hub motor includes an axle, a stator, a rotor, a planetary gear set, a casing, and a sleeve. The axle is fixed to a frame of the bicycle and has a first end and a second end. The stator is fixed to the axle. The rotor is rotatably sleeved on the axle and rotates around the stator. The planetary gear set has a ring gear. The casing is rotatably sleeved on the axle, connected to the rotor through the planetary gear set, and driven by the rotor, and rotates around the rotor and the axle. The casing has an accommodating space, an axle hole, and an opening. The accommodating space accommodates the stator and the rotor and is communicated with the opening. The axle is arranged to pass through the accommodating space, the axle hole, and the opening along an axial direction of a rotating axis.

### FIELD OF THE INVENTION

The present disclosure relates to a motor, and more particularly to a hub motor installed on a bicycle.

### BACKGROUND OF THE INVENTION

A bicycle is a human-powered vehicle that has a history of more than a century since its development. Because the power of the bicycle mainly comes from humans, it is difficult to drive the bicycle by means of human power when the bicycle is on a steep uphill road. Although the thrust can be increased by changing the gear ratio, the effect is still limited.

A hub motor is a motor that drives the rotation of the casing through an internal mechanism and can be installed on the front or rear wheel of a bicycle to serve as auxiliary power to drive the rotation of the front or rear wheel. In order to increase the output of the hub motor, most of the interior of the hub motor has a planetary gear set that can increase the torque output of the hub motor.

### SUMMARY OF THE INVENTION

The present disclosure provides a hub motor with the advantage of convenient maintenance of internal planetary gear sets.

In order to achieve the above advantage, an embodiment of the present disclosure provides a hub motor suitable to be mounted on a bicycle. The hub motor includes an axle, a stator, a rotor, a planetary gear set, a casing, and a sleeve. The axle is fixed to the frame of the bicycle and has a first end and a second end opposite to the first end. The stator is fixed to the axle and near the first end. The rotor is rotatably sleeved on the axle and suitable for rotating around the stator. The planetary gear set has a ring gear. The casing is rotatably sleeved on the axle, connected to the rotor through the planetary gear set and driven by the rotor, and is suitable for rotating around the rotor and the axle. The casing has an accommodating space, an axle hole, and an opening. The accommodating space accommodates the stator and the rotor and is communicated with the opening. The axle is arranged to pass through the accommodating space, the axle hole, and the opening along an axial direction of a rotating axis. An outer surface of the sleeve has a screwing part. The screwing part screws a threaded part located on a side of the accommodating space near the second end. An inner surface of the sleeve has an engaging part, and the engaging part is engaged with the ring gear.

In one embodiment, the sleeve has a first section and a second section. The first section is near the first end. The second section is near the second end. The screwing part is in the first section. The engaging part is in the second section. An outer diameter of the second section is greater than an outer diameter of the first section.

In one embodiment, the opening has a major diameter section and a threaded section. The major diameter section is closer to an outer side of an axial direction of the casing than the threaded section. An inner diameter of the major diameter section is greater than an inner diameter of the threaded section and an outer diameter of the first section or the second section of the sleeve.

In one embodiment, the outer surface of the sleeve has a first push-against part in a direction from the second section to the first section. The first push-against part is suitable for pushing against the casing when the sleeve is screwed to the casing.

In one embodiment, the casing includes a front cover covering the opening. The front cover has a first against part against the second section screwed to the threaded part.

In one embodiment, the inner surface of the sleeve has a second push-against part in a direction from the first section to the second section. The second push-against part pushes against the ring gear.

In one embodiment, the casing includes a front cover covering the opening. The front cover has a second against part against the ring gear.

In one embodiment, the ring gear is engaged with the sleeve through an interference fit.

Based on the above description, in the hub motor of the present disclosure, the ring gear of the planetary gear set is tightly connected to the sleeve through interference fit and then fastened onto the casing through the threads on the sleeve. Therefore, when replacing the ring gear during maintenance, the ring gear can be quickly separated from the casing by separating the casing from the sleeve, thereby preventing damage to the casing when separating the ring gear from the casing directly in the prior art.

Other objectives, features, and advantages of the invention will be further understood from the further technological features disclosed by the embodiments of the present disclosure wherein there are shown and described preferred embodiments of this invention, simply by way of illustration of modes best suited to carry out the invention.

### BRIEF DESCRIPTION OF THE DRAWINGS

FIG. 1A is a schematic exploded view of a hub motor according to an embodiment of the present disclosure;

FIG. 1B is a schematic exploded view of the hub motor in FIG. 1A from another viewing angle;

FIG. 2 is a schematic cross-sectional view of the hub motor in FIG. 1A;

FIG. 3A is a schematic enlarged view of the position where the sleeve is installed in FIG. 2;

FIG. 3B is a schematic three-dimensional enlarged view of the assembly of the sleeve, the ring gear, and the front cover in FIG. 2;

FIG. 4 is a schematic enlarged view of the position where a sleeve of a hub motor is installed in another embodiment of the present disclosure; and

FIG. 5 is a schematic enlarged view of the position where a sleeve of a hub motor is installed in another embodiment of the present disclosure.

### DETAILED DESCRIPTION OF PREFERRED EMBODIMENTS

Terms used in the description of the embodiments of the present disclosure, for example, orientation or position relation such as “above” and “below” are described according to the orientation or position relation shown in the drawings. The above terms are used for facilitating the description of the present disclosure rather than limiting the present disclosure, i.e., indicating or implying that the mentioned elements have to have specific orientations and to be configured in the specific orientations. In addition, terms such as “first” and “second” involved in the description or claims are merely used for naming the elements or distinguishing different embodiments or ranges rather than limiting the upper limit or lower limit of the quantity of the elements.

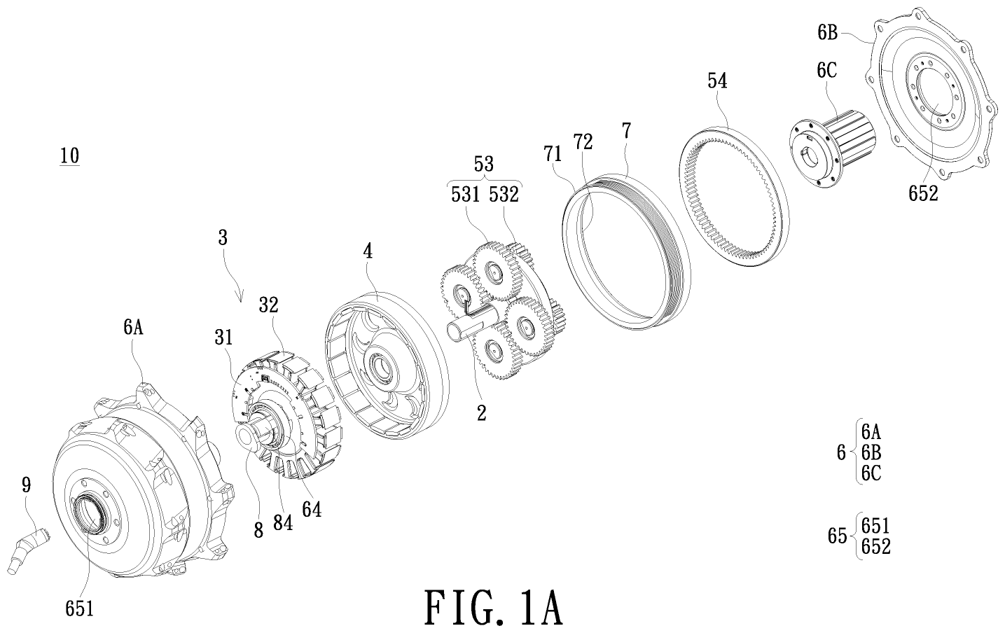

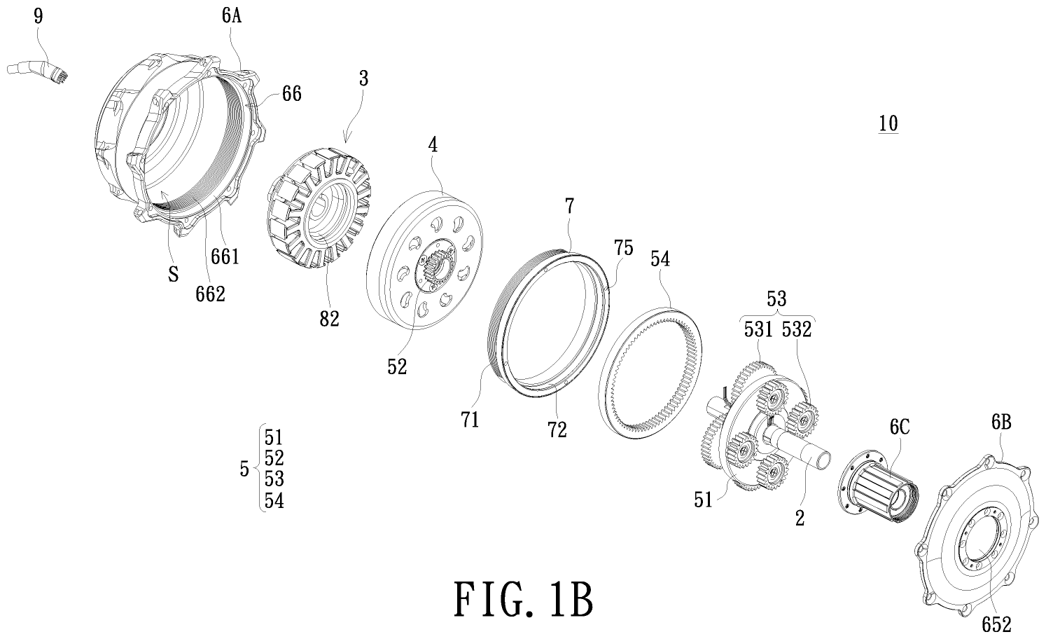

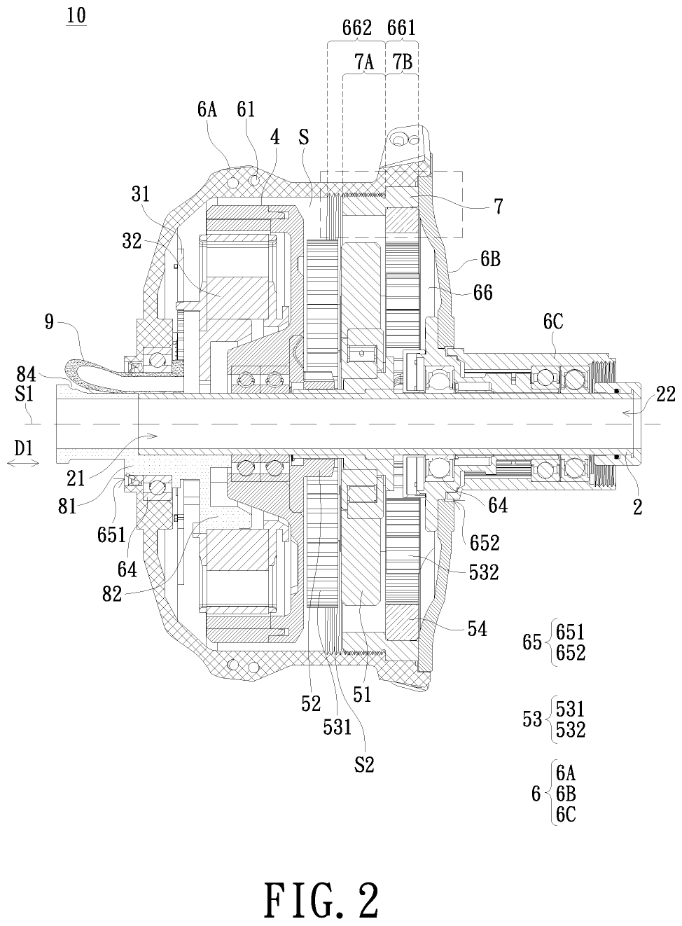

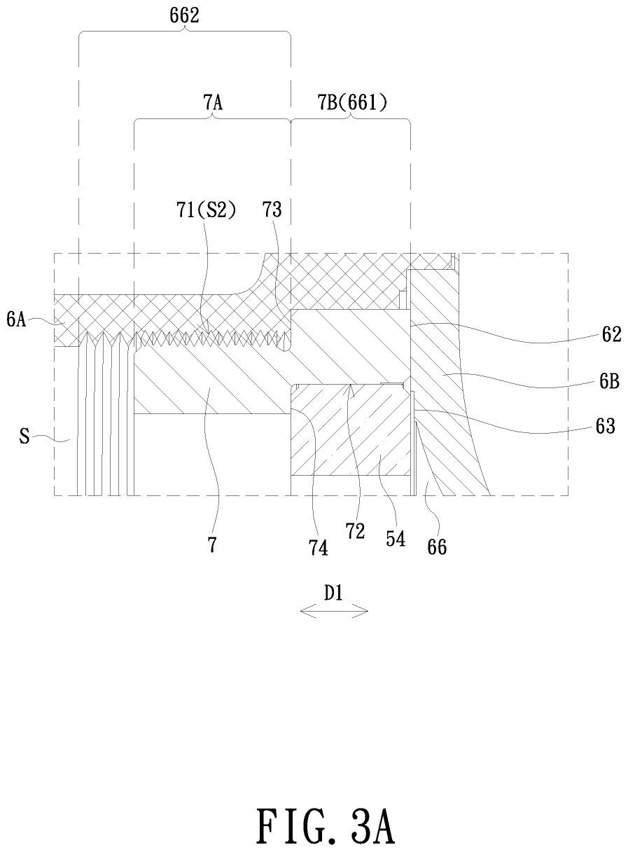

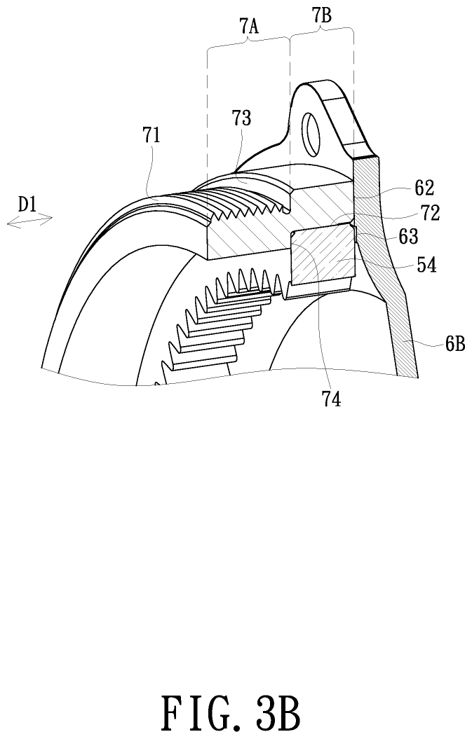

FIG. 1A is a schematic exploded view of a hub motor according to an embodiment of the present disclosure. FIG. 1B is a schematic exploded view of the hub motor in FIG. 1A from another viewing angle. FIG. 2 is a schematic cross-sectional view of the hub motor in FIG. 1A. FIG. 3A is a schematic enlarged view of the position where the sleeve is installed in FIG. 2. FIG. 3B is a schematic three-dimensional enlarged view of the assembly of the sleeve, the ring gear, and the front cover in FIG. 2. As shown in FIG. 1A to FIG. 2, the hub motor 10 provided by this embodiment is suitable to be mounted on a bicycle (not shown) and includes an axle 2, a stator 3, a rotor 4, a planetary gear set 5, a casing 6, and a sleeve 7. The axle 2 is fixed to the frame (not shown) of the bicycle and has a first end 21 and a second end 22 opposite to the first end 21. The stator 3 is fixed on the axle 2 and near the first end 21. The rotor 4 is rotatably sleeved on the axle 2 and suitable for rotating around the stator 3. The planetary gear set 5 has a ring gear 54. The casing 6 is rotatably sleeved on the axle 2, driven by the rotor 4 by connecting to the rotor 4 through the planetary gear set 5, and is suitable for rotating around the rotor 4 and the axle 2. The casing 6 has an accommodating space S (see FIG. 2), an axle hole 65 (see FIG. 2), and an opening 66 (see FIG. 2). The accommodating space S accommodates the stator 3 and the rotor 4 and is communicated with the opening 66. The axle 2 is arranged to pass through the accommodating space S, the axle hole 65, and the opening 66 in the rotation axis S1. The outer surface of the sleeve 7 has a screwing part 71. The screwing part 71 is suitable for screwing the threaded part S2 on the side of the accommodating space S near the second end 22. The inner surface of the sleeve 7 has an engaging part 72. The shape of the engaging part 72 corresponds to the shape of the outer surface of the ring gear 54, for example, to make the engaging part 72 engage with the ring gear 54.

In this embodiment, the hub motor 10 is, for example, mounted on the rear wheel of the bicycle. The axle 2 is, for example, fixed to the frame of the bicycle. The casing 6 is, for example, indirectly connected to a wheel frame of the rear wheel of the bicycle through a plurality of spokes connected to a plurality of holes 61 in the casing 6, so that the casing 6 drives the rear wheel to rotate when rotating. The mounting position of the hub motor 10 is not limited to the rear wheel.

As shown in FIG. 1A to FIG. 2, the casing 6 in this embodiment includes, for example, a body 6A, a front cover 6B, and a ratchet seat 6C. The accommodating space S is formed inside the body 6A. The holes 61 are located on the outer surface of the body 6A. The front cover 6B is used to cover the opening 66 on one side of the body 6A so as to protect components such as the axle 2, the stator 3, the rotor 4, the planetary gear set 5, etc. The casing 6 is provided with a first through-hole 651 and a second through-hole 652 as the axle hole 65 on the body 6A and the front cover 6B, respectively. The ratchet seat 6C passes through the accommodating space S through the second through-hole 652 and is rotatably sleeved on the axle 2. The ratchet seat 6C is suitable for connecting the sprockets of the bicycle. The accommodating space S is provided with rolling bearings 64 near the first through-hole 651 and the second through-hole 652, respectively. The casing 6 is rotatably sleeved on the axle 2 through the rolling bearings 64. The rolling bearing 64 is, for example, a radial bearing, but the type of the rolling bearing 64 is not limited thereto.

In this embodiment, the stator 3 includes, for example, a control unit 31 and an electromagnet assembly 32. The electromagnet assembly 32 is configured to generate a magnetic field through the current provided by the power cord 9, causing, for example, the rotor 4 containing a magnet to rotate relative to the stator 3, and the rotor 4 drives the casing 6 to rotate through the planetary gear set 5. The control unit 31 is configured to control the magnitude of the current passing through the electromagnet assembly 32 to control the magnetic field intensity generated by the electromagnet assembly 32, thereby controlling the speed of the casing 6.

As shown in FIGS. 1A to 2, the planetary gear set 5 in this embodiment includes, for example, a disc body 51, a central gear 52, four planetary gears 53, and a ring gear 54. The disc body 51 is sleeved on the axle 2 and suitable for rotation with the axle 2 as the axis. The central gear 52 is, for example, connected to the rotor 4 and suitable for rotating around the axis of the axle 2 as the rotor 4 rotates. The four planetary gears 53 are installed on the disc body 51 and arranged in a circular pattern centered on the axle 2. Each planetary gear 53 includes a first driven-gear 531 and a second driven-gear 532. The diameters of the first driven-gear 531 and the second driven-gear 532 are different. The first driven-gear 531 is located on the side of the disc body 51 near the rotor 4 and is suitable for meshing the central gear 52. The second driven-gear 532 is located on the side of the disc body 51 far away from the rotor 4 and suitable for meshing the ring gear 54. The ring gear 54 is tightly engaged onto the sleeve 7, for example, through an interference fit. Therefore, when the rotor 4 rotates, it drives the components of the planetary gear set 5 to rotate to drive the casing 6 to rotate.

As shown in FIGS. 1A to 2, the hub motor 10 in this embodiment further includes, for example, a connector 8. The connector 8 has a central pillar 81 (see FIG. 2) and a positioning disc 82 (see FIG. 2). The positioning disc 82 is located at one end of the central pillar 81 near the second end 22 of the axle 2 and is suitable for connecting to the stator 3. The central pillar 81 is fixed to the axle 2. The end of the central pillar 81 far away from the positioning disc 82 penetrates the body 6A through the first through-hole 651 and is connected to the bicycle frame during assembly, and a groove 84 allowing the power code 9 to enter the accommodating space S through the first through-hole 651 is formed. But the shape of the connector 8 is not limited thereto.

As shown in FIGS. 3A and 3B, the sleeve 7 in this embodiment has, for example, a first section 7A and a second section 7B. When the first section 7A is assembled with the casing 6, the first section 7A is near the first end 21 of the axle 2, and the second section 7B is near the second end 22 of the axle 2. The screwing part 71 is located in the first section 7A, and the engaging part 72 is located in the second section 7B. The outer diameter of the second section 7B is greater than the outer diameter of the first section 7A, but the shape of the sleeve 7 is not limited thereto.

As shown in FIGS. 1B and 2, corresponding to the shape of the sleeve 7, the opening 66 on the body 6A in this embodiment has, for example, a major diameter section 661 and a threaded section 662. The major diameter section 661 is closer to the axial outer side of the casing 6 than the threaded section 662. The inner diameter of the major diameter section 661 is greater than the inner diameter of the threaded section 662 and also greater than the outer diameter of the first section 7A of the sleeve 7. The threaded section 622 forms the threaded part S2. In the extension direction D1, the length of the threaded section 662 is greater than the length of the major diameter section 661 and also greater than the length of the screwing part 71 of the sleeve 7. In this embodiment, the inner diameter of the major diameter section 661 corresponds to the outer diameter of the second section 7B, which allows the second section 7B of the sleeve 7 to slide and sleeve in the major diameter section 661 of the opening 66. The detailed dimensional relationships of the above sections are only examples and are not limited thereto and can be modified according to the design of the sleeve 7.

As described above, because the sleeve 7 is screwed to the casing 6, a rotation between the sleeve 7 and the casing 6 may happen between the screwing part 71 and the threaded section 662 with the relative rotation between the rear wheel and the planetary gear set 5 when the hub motor 10 is activated, making it possible for the sleeve 7 to move in the extension direction D1 of the axle 2. Thus, in this embodiment as shown in FIGS. 3A and 3B, the outer surface of the sleeve 7 has a first push-against part 73 in the direction from the second section 7B to the first section 7A. The first push-against part 73 is suitable for pushing against the body 6A when the sleeve 7 is screwed to the body 6A. Specifically, the first push-against part 73 is formed between the first section 7A and the second section 7B of the sleeve 7 (due to the different outer diameters of the first section 7A and the second section 7B). The front cover 6B has a first against part 62, which is against the second section 7B of the sleeve 7 screwed to the threaded part S2. Therefore, the sleeve 7 is engaged by the body 6A of the casing 6 and the front cover 6B on both sides during assembly and will not move in the accommodating space S after assembly. The structure for fixing the sleeve 7 does not affect the first section 7A where the screwing part 71 of the sleeve 7 is located, and the position of the sleeve 7 is not affected as long as the length of the threaded section 662 on the opening 66 is greater than the length of the first section 7A.

In this embodiment, the inner surface of the sleeve 7 has a second push-against part 74 in the direction from the first section 7A to the second section 7B, and the second push-against part 74 pushes against the ring gear 54. The front cover 6B has a second against part 63, which is against the ring gear 54. Therefore, when the ring gear 54 is assembled with the sleeve 7, the ring gear 54 is engaged by the second push-against part 74 of the sleeve 7 and the second against part 63 of the front cover 6B on both sides of the extension direction D1, so that the ring gear 54 does not move in the accommodating space S after assembly.

In addition, in this embodiment as shown in FIGS. 1B and 2, the second section 7B of the sleeve 7 is provided with a plurality of blind holes 75 on the side adjacent to the front cover 6B during assembly. A tool (not shown) can be inserted into the blind holes 75 to rotate the sleeve 7 when the sleeve 7 is screwed onto the threaded part S2. However, the configuration for assisting the sleeve 7 in installation is not limited thereto.

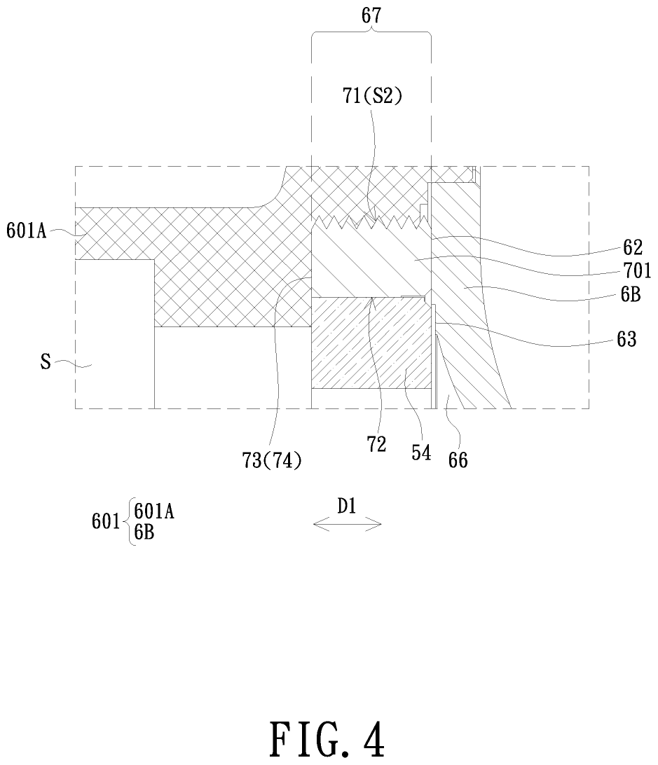

FIG. 4 is a schematic enlarged view of the position where a sleeve of a hub motor is installed in another embodiment of the present disclosure. In this embodiment, the shapes of the sleeve 701 and the body 601A of the casing 601 are different from those in the aforementioned embodiment. Specifically, in this embodiment, the sleeve 701 is a cylinder in which the outer diameter and the inner diameter do not change in the extension direction D1, and the length of the sleeve 701 in the extension direction D1 corresponds to the thickness of the ring gear 54 in the extension direction D1. The engaging part 72 is located on the inner surface of the sleeve 701, the screwing part 71 is located on the outer surface of the sleeve 7, and a side surface of the sleeve 701 in the extension direction D1 is formed with the first against part 62.

Corresponding to the sleeve 701, the body 601A is formed with a receiving groove 67 in the shape corresponding to the sleeve 701 on the side near the opening 66 in the accommodating space S, thereby being suitable for assembling the sleeve 701. The axial surface of the receiving groove 67 facing the opening 66 is formed with the second push-against part 74, and the radial inner surface of the receiving groove 67 is formed with the threaded part S2. As shown in FIG. 4, the first push-against part 73 in this embodiment contacts the second push-against part 74, thereby preventing the sleeve 701 and the ring gear 54 from moving towards the first through-hole 651 in the extension direction D1.

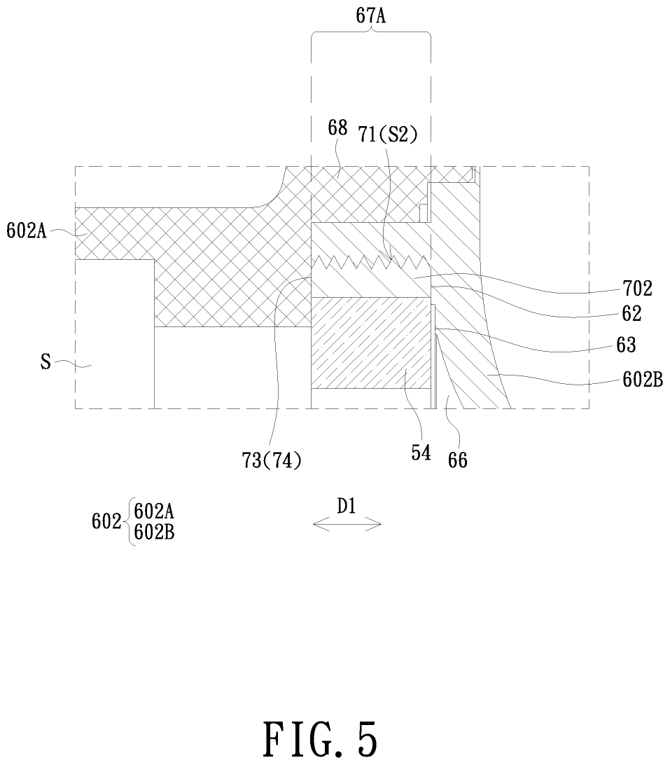

FIG. 5 is a schematic enlarged view of the position where a sleeve of a hub motor is installed in another embodiment of the present disclosure. As shown in FIG. 5, the shape of the sleeve 702 in this embodiment is similar to that of the sleeve 701 in FIG. 4, but the shape of the body 602A and the front cover 602B of the casing 602 are different. The following will only describe the differences.

Specifically, in the embodiment of FIG. 5, the front cover 602B is formed with a convex ring 68 on the side thereof facing the accommodating space S. The inner surface of the convex ring 68 is formed with a threaded part S2. The body 602A is formed with a receiving groove 67A on the side near the front cover 602B in the accommodating space S. The inner diameter of the receiving groove 67A corresponds to the outer diameter of the convex ring 68 on the front cover 602B to store the convex ring 68. Therefore, during the assembly, the sleeve 702 is first screwed onto the front cover 602B, and then positioned in the accommodating space S through the front cover 602B when the front cover 602B is assembled with the body 602A.

Based on the above description, in the hub motor of the present disclosure, the ring gear of the planetary gear set is tightly connected to the sleeve and then screwed onto the casing through the threads on the sleeve. Therefore, when replacing the ring gear during maintenance, the ring gear can be quickly separated from the casing by separating the casing from the sleeve, thereby preventing damage to the casing when separating the ring gear from the casing directly in the prior art.

What is claimed is:

1. A hub motor, suitable to be mounted on a bicycle, the hub motor comprising:
an axle, fixed to a frame of the bicycle and having a first end and a second end opposite to the first end;
a stator, fixed to the axle and near the first end;
a rotor, rotatably sleeved on the axle and suitable for rotating around the stator;
a planetary gear set, having a ring gear;
a casing, rotatably sleeved on the axle, connected to the rotor through the planetary gear set and driven by the rotor, and suitable for rotating around the rotor and the axle, wherein the casing has an accommodating space, an axle hole, and an opening, the accommodating space accommodates the stator and the rotor and is communicated with the opening, the axle is arranged to pass through the accommodating space, the axle hole, and the opening along an axial direction of a rotating axis; and
a sleeve, wherein an outer surface of the sleeve has a screwing part, the screwing part screws a threaded part located on a side of the accommodating space near the second end, an inner surface of the sleeve has an engaging part, and the engaging part is engaged with the ring gear.

2. The hub motor according to claim 1, wherein the sleeve has a first section and a second section, the first section is near the first end, the second section is near the second end, the screwing part is in the first section, the engaging part is in the second section, and an outer diameter of the second section is greater than an outer diameter of the first section.

3. The hub motor according to claim 2, wherein the opening has a major diameter section and a threaded section, the major diameter section is closer to an outer side of an axial direction of the casing than the threaded section, and an inner diameter of the major diameter section is greater than an inner diameter of the threaded section and an outer diameter of the first section or the second section of the sleeve.

4. The hub motor according to claim 2, wherein the outer surface of the sleeve has a first push-against part in a direction from the second section to the first section, and the first push-against part is suitable for pushing against the casing when the sleeve is screwed to the casing.

5. The hub motor according to claim 4, wherein the casing comprises a front cover covering the opening, and the front cover has a first against part against the second section screwed to the threaded part.

6. The hub motor according to claim 2, wherein the inner surface of the sleeve has a second push-against part in a direction from the first section to the second section, and the second push-against part pushes against the ring gear.

7. The hub motor according to claim 6, wherein the casing comprises a front cover covering the opening, and the front cover has a second against part against the ring gear.

8. The hub motor according to claim 1, wherein the ring gear is engaged with the sleeve through interference fit.
